(19) United States
(12) Patent Application Publication
(10) Pub. No.: US 2008/0241611 A1
(43) Pub. Date: Oct. 2, 2008

(54) MCFC anode for direct internal reforming of ethanol, manufacturing process thereof, and method for direct internal reforming in MCFC containing the anode

(75) Inventors: Sung Pil Yoon, Seongnam-si (KR); Jonghee Han, Seoul (KR); Suk-woo Nam, Seoul (KR); Tae Hoon Lim, Seoul (KR); In-Hwan Oh, Seoul (KR); Hary Devianto, Seoul (KR); Ho-In Lee, Seoul (KR); Hyung Chul Ham, Seoul (KR); Yeong Cheon Kim, Seoul (KR)

Correspondence Address: MERCHANT & GOULD PC, P.O. BOX 2903, MINNEAPOLIS, MN, 55402-0903, US

(73) Assignee: Korea Institute of Science & Technology, Seoul (KR)

(21) Appl. No.: 12/079,671

(22) Filed: Mar. 27, 2008

(30) Foreign Application Priority Data
Mar. 27, 2007 (KR) 10/2007/0029764

(51) Int. Cl. H01M 4/90; H01M 4/92; B05D 3/00; B05D 1/02; B05D 1/18; B05D 1/00

(52) U.S. Cl. 429/13; 429/40; 427/77

(57) ABSTRACT

A direct internal reforming system of ethanol for a molten carbonate fuel cell (MCFC) is provided. An MCFC anode for a direct internal reforming of ethanol, a manufacturing process thereof, and a direct internal reforming method in MCFC where an ethanol solution is injected into the anode are provided. by the simple process of coating the surface of the anode with small quantity of catalyst, the drawback in that the performance of MCFC is degraded when the ethanol is directly used as a fuel is overcome. Further, an additional apparatus such as an external reforming apparatus and additional cost for pelletizing the catalyst powders are not required, which is economical. Furthermore, the performance improvement enables long-term operation, which contributes to commercialization of MCFC.

### BACKGROUND OF THE INVENTION

1. Field of the Invention

The present invention relates to a system for a direct internal reforming of ethanol for a molten carbonate fuel cell (MCFC). More particularly, the present invention relates to an MCFC anode for a direct internal reforming of ethanol, a manufacturing process thereof, and a direct internal reforming method in MCFC where an ethanol solution is injected into the anode.

2. Description of the Prior Art

An MCFC is well-known future energy source. Since the MCFC is operated at high temperature (below 650° C.), gas produced from the generation of electricity can be used as a heat source for other purpose, and such a combination between heat and energy has efficiency of up to 60%. Being operated under high temperature, the MCFC can be electrochemically operated sufficiently in electrode catalyst even with transition metal (Ni, etc.) other than expensive inactive catalyst. In addition, in a direct internal reforming MCFC, a reforming reaction can occur in an anode chamber so that diverse fuels can be directly used as an anode injection.

Hydrogen is the best fuel for MCFC due to its high performance, but has a drawback in that mass production thereof needs high-priced production process. To solve this problem, ethanol has been advantageously proposed, which can be produced by fermentation of very cheap crops such as sugar canes or bagasses, be easily treated due to having a water-soluble property, and be easily carried as it has a form of liquid by nature. Further, the ethanol has low toxicity differently from methanol, is bio-degraded, and has no sulfur.

In particular, bio-ethanol is a kind of ethanol, and is extracted from a fermentation process of sugar cane, wheat, or rice. The bio-ethanol contains ethanol by about 5 to 20 vol %, and even with such a low composition of ethanol, it can be directly used as an anode injection without an additional process such as distillation for increase in concentration of ethanol. Since water is the most component in the bio-ethanol, a steam reforming is the proper method for obtaining hydrogen from bio-ethanol.

The steam reforming is a well-known process. In the past, a methane steam reforming had been used, but an ethanol steam reforming has been studied from 1992 by Luengo's group, who has been examined transition metals and metal oxides as active catalyst and a catalyst support, respectively, and the steam reforming being carried out in diverse ratios of water to ethanol at a temperature range between 300 and 550° C. When ethanol is mixed with water at 650° C., following seven reactions can occur.

C₂H₅OH+3H₂O->2CO₂+6H₂ H=+173.5 kJ/mol

C₂H₅OH+H₂O->2CO₂+4H₂ H=+255.7 kJ/mol

C₂H₅OH->CO+CH₄+H₂

C₂H₅OH->CH₄+H₂O

C₂H₅OH->CH₃CHO+H₂

2C₂H₅OH->CH₃COCH₃+CO+3H₂

CO+H₂O->CO₂+H₂ H=−41.1 kJ/mol

In the reactions, “C₂H₅OH+3H₂O->2CO₂+6H₂H=+173.5 kJ/mol” is a reaction for reforming ethanol. In order to increase production of hydrogen with right-shift of equilibrium, conditions of high temperature, low pressure, and high ratio of water to ethanol are needed. The steam reforming reaction is enhanced by catalyst, in which nickel has been tested as an active metal catalyst. Ni promotes C—C bonding to be broken, and increases the selectivity of hydrogen. Further, Ni enhances ethanol vaporization and decreases the selectivity to acetaldehyde and acetic acid.

Regarding the catalysis of catalyst, a problem of inactivity of the catalyst should be solved. The inactivity of the catalyst can be caused by the formation of cokes, the sintering of catalyst, toxicity of electrolyte, etc. According to studies, the bio-ethanol containing ethanol by 5 to 20% is out of cokes formation range, so that it has no problem of inactivity by cokes formation. However, in case of high partial pressure of steam, particularly, at high temperature, catalyst gets sintered, being inactivated. In connection with this, metal supported catalyst can be a solution thereof. Among metal oxides as a catalyst support, MgO is proper because it functions as a basic carrier that prohibits the formation of cokes.

In the meantime, the catalyst can be positioned in a specified reforming apparatus outside the MCFC stack requiring additional heat supply (external reforming); other chamber than an anode inside the MCFC stack not requiring additional heat supply (indirect internal reforming); or the same chamber as an anode inside the MCFC stack (direct internal reforming). The simplest and cheapest system is the direct internal reforming, but in order to be positioned in the anode chamber, the catalyst has to be palletized so that additional cost occurs.

### SUMMARY OF THE INVENTION

Accordingly, an object of the present invention is to provide a direct internal reforming system of ethanol that directly uses the ethanol as a fuel, and maintains the performance of molten carbonate fuel cell (MCFC) highly and stably. To provide the system, the present invention proposes an MCFC anode for a direct internal reforming of ethanol, a manufacturing process thereof, and a direct internal reforming method in MCFC where an ethanol solution is injected into the anode.

In order to accomplish the above object, the present invention provides an MCFC anode for direct internal reforming of ethanol wherein a catalyst layer fixed by a metal oxide is coated on the anode.

In the MCFC anode, the catalyst layer is transition metal including Ni, Co, Fe or Cu, or noble metal including. Pt, Pd, Ru, or Rh. The metal oxide is Al₂O₃, MgO, ZnO, or CeO₂. The catalyst layer is porous, and has a thickness of 140 to 160 μm, or a weight of 4 to 6 wt % relative to total anode weight. Beyond the range, the performance of the fuel cell becomes degraded.

Further, the present invention provides a method of manufacturing a molten carbonate fuel cell (MCFC) anode for direct internal reforming of ethanol, the method comprising (a) coating the MCFC anode with catalyst paste (S1); and (b) calcining the catalyst-coated anode under a reduction atmosphere (S2).

In the method, the catalyst paste in the step (a) is made by heating a catalyst slurry prepared by adding the transition metal powders or noble metal catalyst powders supported by metal oxides to binder, plasticizer, homogenizer, dispersing agent, and solvent. The coating in the step (a) is carried out by a spray coating, a hot-pressing or a brush coating for only one side of the anode, or by a combination of side coating and dipping coating.

Furthermore, the present invention provides a direct internal reforming method of molten carbonate fuel cell (MCFC) including the anode, the method comprising the step of injecting an ethanol solution and carrier gas into the anode.

In the direct internal reforming method, the ethanol solution contains ethanol of 5 to 20 vol % relative to whole volume, and the ethanol solution is bio-ethanol. The carrier gas is inactive and does not affect an ethanol partial pressure. The carrier gas is N₂, He or Ar.

In the direct internal reforming method, a direct internal reforming reaction of MCFC occurs at 600 to 700° C.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a schematic operating principle of molten carbonate fuel cell (MCFC) including a catalyst-coated anode;

FIG. 2 illustrates a comparison result of catalyst activities between examples 1 to 3 and a comparative example 1 of the present invention;

FIG. 3 is a process view illustrating a manufacturing procedure of the MCFC anode coated with a catalyst layer according to an example 4 of the present invention;

FIG. 4 is a photograph of a scanning electronic microscope (SEM) of the MCFC anode coated according to the example 4 of the present invention;

FIG. 5 illustrates the performance test results of unit cells including an anode coated according to the example 4 and an anode not coated according to a comparative example 2 of the present invention;

FIG. 6 illustrates the stability test results of unit cells of direct internal reforming MCFC using bio-ethanol according to an embodiment of the present invention;

FIG. 7 illustrates the performance test results of unit cells of direct internal reforming MCFC using bio-ethanol in diverse concentrations according to an embodiment of the present invention; and

FIG. 8 illustrates the performance test results of unit cells of direct internal reforming MCFC using bio-ethanol in diverse operating temperatures according to and embodiment of the present invention.

### DETAILED DESCRIPTION OF THE EXEMPLARY EMBODIMENTS

Hereinafter, exemplary embodiments of the present invention will be described with reference to the accompanying drawings.

FIG. 1 illustrates a schematic operating principle of molten carbonate fuel cell (MCFC) including a catalyst-coated anode. As illustrated in FIG. 1, the present invention accomplishes a direct internal reforming in MCFC by coating an anode with a catalyst layer which can enhance a reaction of C₂H₅OH+3H₂O->2CO₂+6H₂, which is a steam reforming reaction using ethanol. Herein, the catalyst layer is porous so that hydrogen product gas can permeate into the anode.

Although the present invention will now be explained in detail referring to following examples, they are only illustrative so the present invention is not limited thereto.

### Examples 1 to 3 and Comparative Example 1

The inventors prepared Ni catalyst group fixed by Mgo (example 1), ZnO (example 2), and CeO₂ (example 3) using co-precipitation method. As the comparative example, 12 wt % Ni/Al₂O₃ (FCR-4) available by Sud Chemie was prepared for use in preliminary test (comparative example 1).

<Catalyst Activity Test>

A catalyst activity test was carried out to examine the performances of the catalysts of examples 1 to 3 and comparative example 1 for ethanol steam reforming reaction. The catalyst activity was measured from data of a conversion rate into ethanol, a degree of hydrogen production selectivity, and a hydrogen production yield rate. The catalysts each were processed so that approximately 0.1 g of catalyst was put on a grid in a quarts reactor in a furnace, and bio-ethanol (20 vol %) was injected thereto at a rate of 0.06 mL/min through a syringe pump. A temperature was adjusted to 650° C. similar to a temperature condition in the direct internal reforming of MCFC. Before the test, a pretreatment process for reducing the catalysts with 20% H₂/N₂ was carried out for one hour.

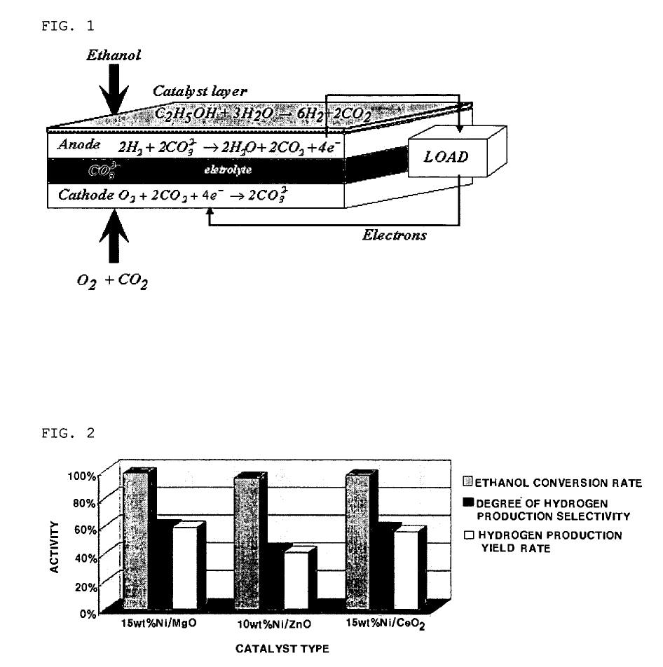

According to reference documents, at low ethanol concentration (bio-ethanol), Ni/ZnO (example 2), and at high temperature, Ni/CeO₂ (example 3) are the excellent catalysts. However, as a test result, according to data of a conversion rate into ethanol, a degree of hydrogen production selectivity, and a hydrogen production yield rate in FIG. 2, although Ni/ZnO (example 2) and Ni/CeO₂ (example 3) have excellent performances, Ni/MgO (example 1) has the highest hydrogen production yield rate and excellent ethanol conversion rate and hydrogen production selectivity. Thus, Ni/MgO catalyst was used for following diverse tests.

### Example 4

### Surface-Coating of Anode

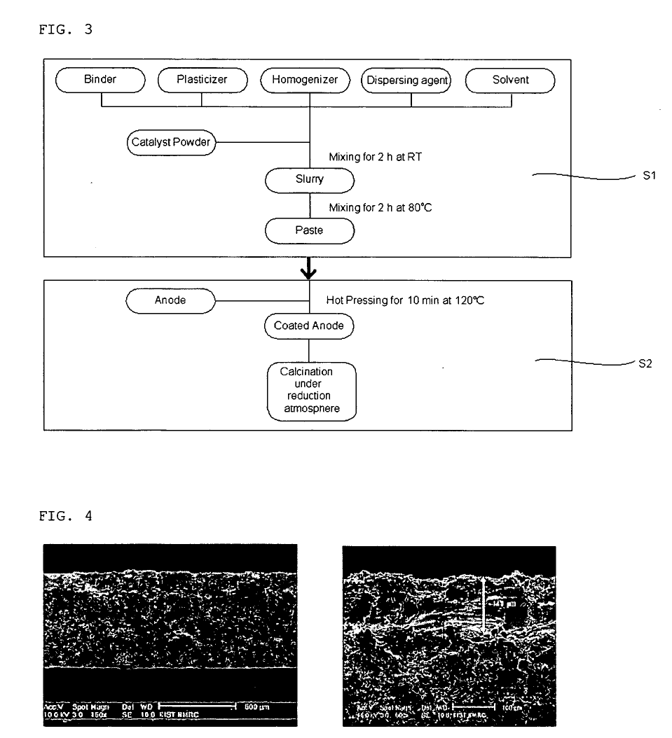

FIG. 3 is a process view illustrating a manufacturing procedure of the MCFC anode coated with a catalyst layer according to an example 4 of the present invention. MCFC anode was prepared by conducting a series of processes of tape casting, drying, and calcination of a slurry in which solvent (water), binder (methyl cellulose #1500; Junsei Chemical Co., Japan), plasticizer (glycerol, Junsei Chemical Co., Japan), antifoaming agent (SN-154; San Nopco, Korea), aggregation inhibitor (cerasperse-5468; San Nopco, Korea), and nickel powders (INCO #255; particle size: 3 μm) were mixed. The catalyst slurry was prepared by adding 2 g of 15 wt % Ni/MgO catalyst to 50 mL water-ethanol (1:1) solution mixed with 0.4 g binder (PVB B30H), 0.4 g plasticizer (DBP), 5 droplets homogenizer (Triton), and 10 droplets dispersing agent (Disperbyk 110), and mixing them at room temperature for 2 hours. The prepared slurry has viscosity of about 3000 cP, so it was heated at 80° C. for 2 hours in order to make paste having viscosity of about 5000 cP. The coating of the anode with catalyst paste prepared was carried out by hot-pressing method so that the catalyst paste was put on the anode and was pressed with a pressure of 3 kgf/cm² at 120° C. for 10 minutes. The coated anode was calcined at 700° C. for 3 hours under 20% H₂/N₂ atmosphere. FIG. 4 illustrates scanning electronic microscope (SEM) images of the coated anode. As a result, a catalyst layer of 143 μm was formed on one side of the anode, and hydrogen is to be produced there.

### Comparative Example 2

An uncoated MCFC anode was prepared with the same method as example 4, excluding that it was not coated with 15 wt % Ni/MgO catalyst.

<Comparison of Performances of Unit Cells of Bio-Ethanol Direct Internal Reforming MCFC of which Anode Surface is Coated with Catalyst or not>

To analyze the performance of the MCFC using bio-ethanol (20 vol %) according to the face of whether or not the anode surface thereof is coated with catalyst, unit cell (10×10 cm²) was used. Test conditions and operational characteristics of the unit cell were summarized by Table 1.

TABLE 1

| Element of Unit Cell | Value and Characteristic |
|---|---|
| Cell Frame of Anode and Cathode | |
| Size (Width, × Length: cm × cm) | 13 × 13 |
| Material | Aluminum Treated SUS-316 |
| Anode and Current Collector | |
| Size (Width × Length: cm × cm) | 11 × 11 |
| Thickness (mm) | ca. 0.75 |
| Porosity | 55-60% |
| Pore Size (μm) | 3-4 |
| Material (Electrode; Current | Ni-10 wt % Cr, CeO₂ |
| Collector) | coating; Ni |
| Mole Fraction of Fuel Gas | 72:18:10 |
| (H₂:CO₂:H₂O) | |
| Total Flow Rate | 365 mL/min |
| Cathode and Current Collector | |
| Size (Width × Length: cm × cm) | 10 × 10 |
| Thickness (mm) | ca. 0.65 |
| Porosity | 60-65% |
| Pore Size (μm) | 7-8 |
| Material (Electrode; Current | In-Situ Lithiated NiO; |
| Collector) | SUS 316 |
| Mole Fraction of Oxidizer Gas | 70:30 |
| (Air:CO₂) | |
| Total Flow Rate | 950 mL/min |
| Electrolyte | |
| Li₂CO₃:K₂CO₃ Mole Fraction | 62:38 |
| Matrix | LiAlO₂ |

The anode coated with the catalyst layer according to the example 4 and the uncoated anode manufactured according to comparative example 2 were put on a heating block together with a cathode, electrolyte, a matrix, a current collector, and a cell frame forming an MCFC unit cell, and a pressure of 2 kgf/cm² was exerted to the unit cell using an air cylinder. Pretreatment was carried out at 25 to 450° C. for 3 days under atmosphere condition, and at 450 to 650° C. for 3 days under CO₂, and 10×10 cm² unit cell was operated. Since the pretreatment under CO₂ is very important in electrolyte melting, the distribution of electrolyte was maintained through pores of the matrix, the cathode, and the anode, and the electrolyte was allowed to flow through the system very slowly to prevent from the evaporation of the electrolyte. After the pretreatment, the gas temperature of MCFC was maintained at 650° C. for 100 hours. Then, bio-ethanol (20 vol %) was injected with carrier gas (N₂) to provide bio-ethanol (20 vol %) with sufficient pressure, and normal anode and cathode gases were injected. The anode gas was composed of H₂, CO₂, and H₂O with a mole fraction of 72:18:10, and the cathode gas was composed of air and CO₂ with a mole fraction of 70:30.

FIG. 5 illustrates the performance test results of unit cells including 15 wt % Ni/MgO coated anode according to the example 4 and uncoated anode according to the comparative example 2. As illustrated in FIG. 5, it can be known that coating the surface of the anode with the catalyst is essential to increase in performance of the unit cell.

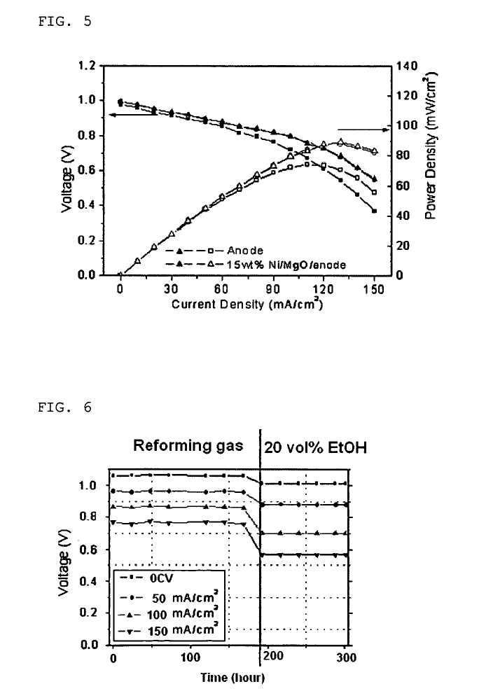

Meanwhile, FIG. 6 illustrates the stability test results of unit cells of direct internal reforming MCFC using bio-ethanol according to an embodiment of the present invention. As illustrate in FIG. 6, the direct internal reforming MCFC unit cell using bio-ethanol can maintain constant voltage even at high current density.

<Performance of Direct Internal Reforming MCFC Unit Cell Using Bio-Ethanol with Diverse Concentrations>

The performance of the direct internal reforming MCFC unit cell using bio-ethanol with 5 to 15% of concentrations was measured. The result was illustrated in FIG. 7. When the anode was coated with 15 wt % Ni/MgO by hot-pressing, and was operated at 650° C., as the concentration of the bio-ethanol varied, a rate of hydrogen production by steam reforming reaction did not seem to be affected, so that the performances of the unit cells had no difference. That is, in case of using the direct ethanol steam internal reforming system, even though the bio-ethanol is used within a concentration of 5 to 20%, stable and high performance MCFC can be manufactured.

<Performance of Direct Internal MCFC Unit Cell According to Diverse Operating Temperatures>

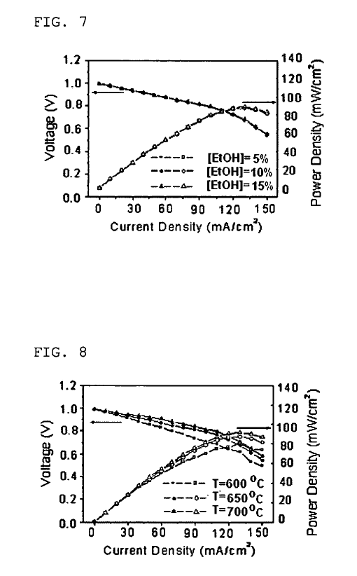

The performance of the direct internal reforming MCFC unit cell using bio-ethanol at an operating temperature of 600 to 700° C. was measured. The result was illustrated in FIG. 8. In FIG. 8, it could be known that the performance at that temperature range was excellent, and in particular, at fixed ethanol concentration (20 vol %), the higher operating temperature was, the higher the power density got. Since the equilibrium state of the steam reforming reaction shifts to the right at high temperature (endothermic reaction), the great quantity of hydrogen is produced, so that high voltage is caused to improve the performance of the unit cell.

As set forth before, by the simple process of coating the surface of the anode with small quantity of catalyst, the drawback in that the performance of MCFC is degraded when the ethanol is directly used as a fuel can be overcome. Further, an additional apparatus such as an external reforming apparatus and additional cost for pelletizing the catalyst powders are not required, which is economical. Furthermore, the performance improvement enables long-term operation, which contributes to commercialization of MCFC.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A molten carbonate fuel cell (MCFC) anode for direct internal reforming of ethanol, wherein a catalyst layer fixed by a metal oxide is coated on the anode.

2. The MCFC anode for direct internal reforming of ethanol according to claim 1, wherein the catalyst layer is transition metal including Ni, Co, Fe or Cu, or noble metal including Pt, Pd, Ru, or Rh.

3. The MCFC anode for direct internal reforming of ethanol according to claim 1, wherein the metal oxide is Al₂O₃, MgO, ZnO, or CeO₂.

4. The MCFC anode for direct internal reforming of ethanol according to claim 2, wherein the metal oxide is Al₂O₃, MgO, ZnO, or CeO₂.

5. The MCFC anode for direct internal reforming of ethanol according to claim 1, wherein the catalyst layer is porous.

6. The MCFC anode for direct internal reforming of ethanol according to claim 2, wherein the catalyst layer is porous.

7. The MCFC anode for direct internal reforming of ethanol according to claim 1, wherein the catalyst layer has a thickness of 140 to 160 μm.

8. The MCFC anode for direct internal reforming of ethanol according to claim 2, wherein the catalyst layer has a thickness of 140 to 160 μm.

9. The MCFC anode for direct internal reforming of ethanol according to claim 1, wherein the weight of the catalyst layer is 4 to 6% of total anode weight.

10. The MCFC anode for direct internal reforming of ethanol according to claim 2, wherein the weight of the catalyst layer is 4 to 6% of total anode weight.

11. A method of manufacturing a molten carbonate fuel cell (MCFC) anode for direct internal reforming of ethanol, the method comprising:
coating the MCFC anode with catalyst paste (S1); and
calcining the catalyst-coated anode under a reduction atmosphere (S2).

12. The method of manufacturing the MCFC anode for direct internal reforming of ethanol according to claim 11, wherein the catalyst paste is made by heating a catalyst slurry prepared by adding transition metal powders or noble metal catalyst powders fixed by a metal oxide to binder, plasticizer, homogenizer, dispersing agent, and solvent.

13. The method of manufacturing the MCFC anode for direct internal reforming of ethanol according to claim 11, wherein the coating is carried out by a spray coating, a hot-pressing or a brush coating for only one side of the anode.

14. The method of manufacturing the MCFC anode for direct internal reforming of ethanol according to claim 11, wherein the coating is carried out by a combination of side coating and dipping coating.

15. A direct internal reforming method of molten carbonate fuel cell (MCFC) including the anode according to claim 1, comprising injecting an ethanol solution and a carrier gas into the anode.

16. The direct internal reforming method of MCFC according to claim 15, wherein the ethanol solution contains ethanol of 5 to 20 vol % relative to the solution.

17. The direct internal reforming method of MCFC according to claim 15, wherein the ethanol solution is bio-ethanol.

18. The direct internal reforming method of MCFC according to claim 15, wherein the carrier gas is inactive and does not affect an ethanol partial pressure.

19. The direct internal reforming method of MCFC according to claim 15, wherein the carrier gas is N₂, He or Ar.

20. The direct internal reforming method of MCFC according to claim 15, wherein the direct internal reforming of MCFC occurs at 600 to 700° C.
